(19) United States
(12) Patent Application Publication
(10) Pub. No.: US 2007/0168971 A1
(43) Pub. Date: Jul. 19, 2007

(54) Multi-tiered model-based application testing

(75) Inventors: Semyon Royzen, San Francisco, CA (US); Thomas Hempel, Redwood City, CA (US)

Correspondence Address: Alfred W. Zaher, Esq.;BLANK ROME LLP, One Logan Square, 130 North 18th Street, Philadelphia, PA, 19103, US

(73) Assignee: Epiphany, Inc., San Mateo, CA (US)

(21) Appl. No.: 11/284,683

(22) Filed: Nov. 22, 2005

(51) Int. Cl. G06F 9/44

(52) U.S. Cl. 717/124

(57) ABSTRACT

Multi-tiered model-based application testing is described, including receiving metadata from the application, the metadata being associated with one or more layers of the application, using the metadata to develop a script configured to test a feature of an application model, and converting the metadata to develop another script configured to test another feature of the application model, wherein the another script is generated by the test framework

### CROSS-REFERENCE TO RELATED APPLICATIONS

This application is related to co-pending U.S. patent application Ser. No. 11/255,363 (Attorney Docket No. EPI-003) entitled “Method and System for Testing Enterprise Applications” filed on Oct. 21, 2005, which is incorporated herein by reference for all purposes.

### FIELD OF THE INVENTION

The present invention relates generally to software. More specifically, multi-tiered model-based application testing is described.

### BACKGROUND

Computer programs or applications “applications” are tested using various conventional techniques. Applications may be client-side, server-side, enterprise, or other types of programs that are used for purposes such as customer relationship management (CRM), enterprise resource planning (ERP), human resources (HR), sales, and others. However, applications are often difficult to implement, integrate, and test and conventional techniques are problematic.

Some conventional techniques completely automate generation of test scripts (i.e., programs, applets, or short applications) that, at design-time and/or run-time, test different aspects of an application. However, many of the features, aspects, or functionality of an application may not be completely or properly tested by conventional testing solutions that rely on automatic test generation. Other conventional techniques include manual generation of test scripts, but these are typically time and labor-intensive and expensive to implement. Further, manual testing is difficult with large scale applications, such as enterprise applications that are intended to service a wide or large-scale set of network users, clients, and servers.

Other conventional techniques use a combination of manual and automatic testing, but these programs often do not effectively utilize available data and metadata to balance the application of manual and automatically generated tests. Another problem is the limitation of conventional techniques to run-time instead of design-time, which can interrupt or disrupt operation of the application. Further, conventional solutions test systems under test (“SUT”) at a single architectural layer, which limits the effectiveness of conventional testing solutions because valuable information that may be interpreted or found at different architectural layers of an application (e.g., presentation, application, data, integration, and other layers) is missed, leading to poor test quality, integration, and execution.

Thus, what is needed is a solution for testing applications without the limitations of conventional implementations.

### BRIEF DESCRIPTION OF THE DRAWINGS

Various embodiments are disclosed in the following detailed description and the accompanying drawings:

FIG. 1 illustrates an exemplary system configured for multi-tiered model-based application testing, in accordance with an embodiment;

FIG. 2 illustrates an exemplary test framework (TF) core configured for multi-tiered model-based application testing, in accordance with an embodiment;

FIG. 3 illustrates an exemplary test framework (TF) model module configured for multi-tiered model-based application testing, in accordance with an embodiment;

FIG. 4 illustrates an exemplary test framework (TF) test module configured for multi-tiered model-based application testing, in accordance with an embodiment;

FIG. 5 illustrates an exemplary test framework (TF) system under test (SUT) adapter block configured for multi-tiered model-based application testing, in accordance with an embodiment;

FIG. 6 illustrates an exemplary process for multi-tiered model-based application testing, in accordance with an embodiment;

FIG. 7 illustrates an exemplary process for configuring a test framework (TF), in accordance with an embodiment;

FIG. 8 illustrates an exemplary process for getting script, action, instance and associated data, in accordance with an embodiment;

FIG. 9 illustrates an exemplary process for forwarding an instance action, in accordance with an embodiment;

FIG. 10 illustrates an exemplary run-time test cycle for a test script generated using a system for multi-tiered model-based application testing, in accordance with an embodiment; and

FIG. 11 is a block diagram illustrating an exemplary computer system suitable for multi-tiered model-based application testing, in accordance with an embodiment.

### DETAILED DESCRIPTION

Various embodiments may be implemented in numerous ways, including as a system, a process, an apparatus, or as computer program instructions included on a computer readable medium such as a computer readable storage medium or a computer network wherein program instructions are sent over optical or electronic communication links. In general, the steps of disclosed processes may be performed in an arbitrary order, unless otherwise provided in the claims.

A detailed description of one or more examples is provided below along with accompanying figures. The detailed description is provided in connection with such examples, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

Multi-tiered model-based application testing is described, including embodiments that may be varied in system design, implementation, and execution. The described techniques may be implemented as a tool or test framework (“TF”) for automated testing of multi-tiered applications developed using a model-based application framework (“AF”). Applications implemented using distributed architectures (e.g., client-server, WAN, LAN, and other topologies) may be tested by using data and metadata (i.e., data that may be used to define or create other objects or instances of objects as defined by a class of a programming language) that are automatically gathered and, in some embodiments, also manually imported into a TF coupled to an application. Metadata from various architectural tiers or layers (e.g., client, business object, services definition/discovery, and others) of an application may be imported and processed to generate test scripts for various features of an application. In some embodiments, architectural schema for applications may be derived from standards setting bodies such as Internet Engineering Task Force (IETF), World Wide Web Consortium (W3C), and others. Data and metadata may be automatically gathered or manually augmented by users (e.g., developers, programmers, system administrators, quality assurance, test personnel, end users, and others) to increase the accuracy and efficiency of a model of an application being tested. Metadata about a business object model may be used by a test framework to generate an XML schema, which in turn can used to generate scripts to test an application or SUT. Further, modifications, deletions, or additions of features to an application may also be tested by re-using or “converting” metadata and tests that were previously imported for generating earlier test scripts. Thus, efficient, rapid test authoring, and comprehensive testing of applications may be performed to reduce design and run-time errors as well as implementation problems.

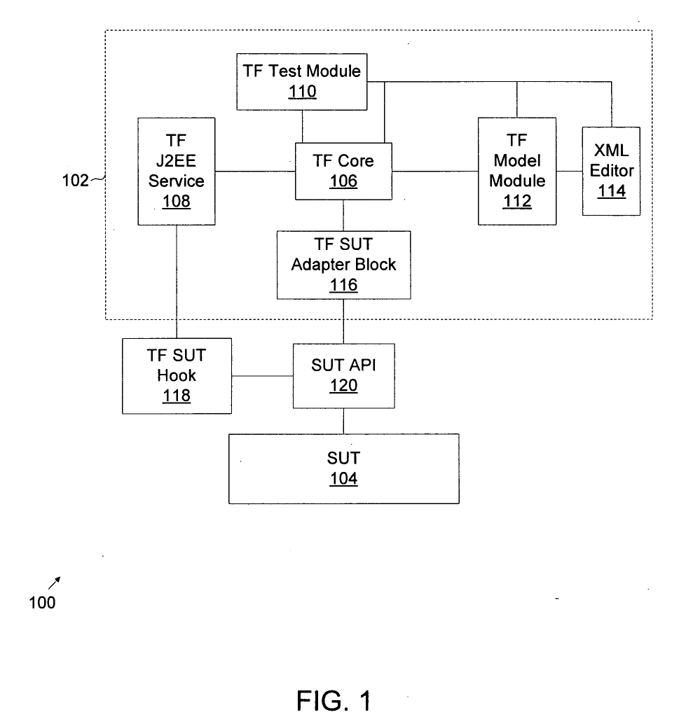

FIG. 1 illustrates an exemplary system configured for multi-tiered model-based application testing, in accordance with an embodiment. Here, system 100 may be used to test a multi-tiered application. In some embodiments, system 100 includes TF 102, system under test (“SUT”) 104, TF core 106, TF Java 2 Enterprise Edition (“J2EE”) Service 108, TF test module 110, TF model module 112, XML editor 114, TF SUT adapter block 116, SUT TF hook 118, and SUT application programming interface (“API”) 120. In other embodiments, system 100 may include more, fewer, or different modules, interfaces, and components apart from those shown. Functionality may also be varied and is not limited to the descriptions provided.

Here, system 100 may be implemented to test SUT 104 using TF 102. TF 102 “gets” or gathers (e.g., requests and receives) metadata from SUT 104, which is passed between system 100 and TF 102 via SUT API 120. Once received, metadata may be input to TF 102 as information provided to TF J2EE service 108 and TF SUT adapter block 116. TF J2EE service 108 provides ajava-based environment (e.g., stateless session bean facade providing remote TF invocation and an event “sink”) for developing and deploying web-based enterprise applications such as TF 102. Also, TF J2EE service 108 receives metadata from SUT 104 and provides data about objects (e.g., BIOs as developed by E. piphany, Inc. of San Mateo, Calif.), which are sent to TF core 106. Using one or more models generated by TF model module 112, tests may be generated using metadata (i.e., objects). In some embodiments, tests may be generated as test scripts output from TF test module 110, which may be applied by TF core 106. TF core 106 generates and applies test scripts produced by TF test module 110 based on models developed by TF model module 112. Further, manually-augmented (i.e., user-entered) metadata may be input to TF 102 using XML editor 114. In some embodiments, XML editor 114 may be implemented using an editing application such as XML Spy. In other embodiments, XML editor 114 may be implemented differently.

Here, SUT 104 may an enterprise application performing CRM, ERP, sales force automation (SFA), sales, marketing, service, or other functions. TF 102 models and generates scripts for testing SUT 104 (i.e., the application framework of SUT 104). Metadata may be gathered from various layers of a services architecture (e.g., client/presentation layer, services definition/discovery layer, communication protocol layer, business/object layer, and others) and used to generate test scripts. In some embodiments, web services architectures and layers may be varied and are not limited to those described, including those promulgated by IETF (e.g., WSDL, and the like). Data may be extracted from multiple layers of SUT 104 by using adapters. TF SUT adapter block 116 is in data communication with various adapters that provide metadata to TF 102. Test scripts may be generated and run quickly, by reusing or converting metadata previously gathered to generate a new individual or set of test scripts. In some embodiments, SUT 104 may be modeled by TF model module 112 using a finite state machine (FSM; not shown). State and object data (e.g., metadata) may be used with a FSM to model of SUT 104, which may be tested without disrupting or interrupting application performance.

In some embodiments, test scripts may be generated automatically, manually, or using a combination of both automatic and generation techniques. A model may be generated to permit manual customization of tests for SUT 104. Metadata may be used to generate data schemas (e.g., XML schema) for use with a service definition capability (e.g., TF J2EE service 108) to model SUT 104, which is tested without interrupting or disrupting performance of SUT 104. At design-time, a developer may use XML editor 114 to input metadata for generating test scripts. At run-time metadata may be automatically gathered from SUT 104 through TF SUT adapter block 116 via SUT API 120, which may be configured to gather metadata from business (i.e., object), user interface (i.e., presentation), and controller layers. The metadata used to generate a model (e.g., AF model) yields an XML schema (e.g., XSD) that may be used to construct the model, which is subsequently tested. System 100 and the above-described functions and components may be varied and are not limited to the descriptions provided.

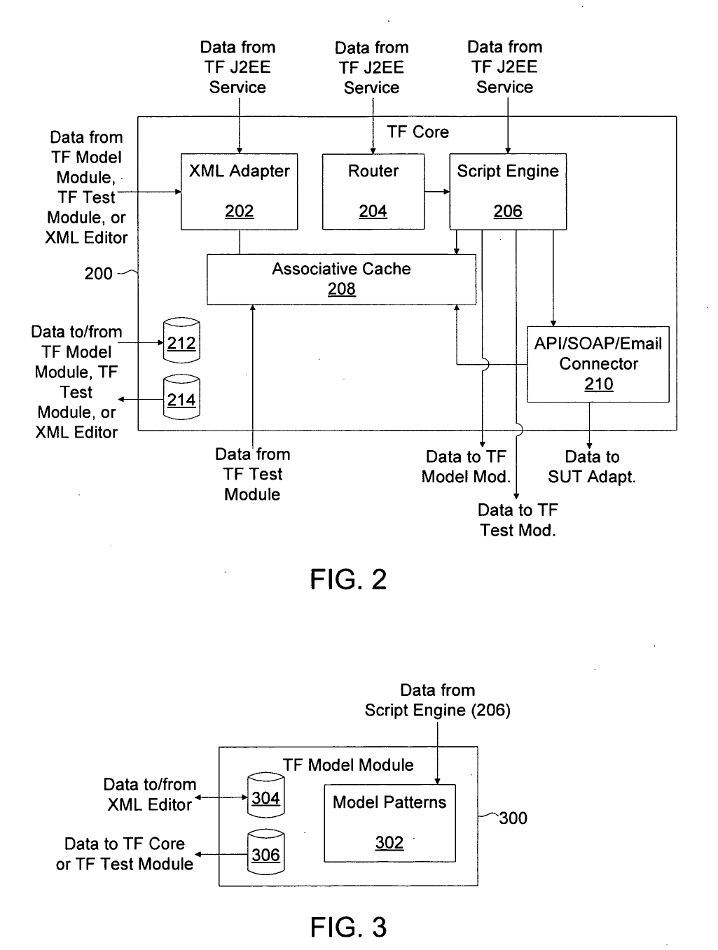

FIG. 2 illustrates an exemplary test framework (TF) core configured for multi-tiered model-based application testing, in accordance with an embodiment. In some embodiments, TF core 200 may be implemented as an in-memory data processing module configured to perform model-based application testing. Here, TF core 200 includes XML adapter 202, router 204, script engine 206, associative cache 208, API/simple object access protocol (SOAP)/email connector 210, API map repository 212, and API map schema repository 214. In other embodiments, TF core 200 may include more, fewer, or different modules, interfaces, and components apart from those shown. Functionality may also be varied and is not limited to the descriptions provided.

Here, TF core 200 uses data (i.e., metadata) uses models generated by TF model module 112 (FIG. 1) and test scripts provided by TF test module 110 in a web services environment provided by TF J2EE service 108. In some embodiments, TF core 200 may be implemented as TF core 106 (FIG. 1). XML adapter 202 receives data from TF J2EE service 108, TF model module 112, TF test module 110, and XML editor 114. XML adapter 202 is in communication with associative cache 208, which may be implemented as a recursive hierarchical/referential in-memory data structure or repository for both data and metadata. In some embodiments, associative cache also provides a semantic network that may be used to determine how to pass data between the various modules of TF core 200 using one or more APIs. Router 204 receives data from TF J2EE service 108, routing events to objects. Further, router 204 also routes data to script engine 206, which receives data from TF J2EE service 108. Script engine 206 generates test scripts that are sent to associative cache 208, TF model module 112 and to SUT 104 via API/Simple Object Access Protocol (SOAP)/Email connector 210. Test scripts are applied to a model of SUT 104 (FIG. 1) generated by TF model module 112. By applying generated test scripts to a model, an application is neither disrupted nor interrupted, increasing efficiency and reliability in testing. Further, if functionality (i.e., a module) is added, deleted, or modified, testing may also be performed without disrupting the modeled enterprise application. API map repository 212 is a database or other data storage implementation that may be used to store data associated with a map between a model and SUT 104 (FIG. 1). API map data from TF model module 112, TF test module 110, and XML editor 114 is stored in API map repository 212. Using API map data in API map repository 212, a data schema or API map schema may be generated and stored in API map schema repository 214. API map repository 212 and API map schema 214 provide maps and supporting data schemas that are used to map a model to an application (e.g., SUT 104). In other embodiments, TF core 200 may be implemented differently and is not limited to the modules, components, functions, and configurations described above.

FIG. 3 illustrates an exemplary test framework (TF) model module configured for multi-tiered model-based application testing, in accordance with an embodiment. In some embodiments, TF model module 300 includes model patterns module 302, model repository 304, and model schema repository 306. In other embodiments, TF model module 300 may include more, fewer, or different modules, interfaces, and components apart from those shown. Here, TF model module 300 may be implemented using XML schema-based XML syntax for application modeling and scripting. TF model module 300 may model data (e.g., specifying entity and relationships), data navigation, data states, data scoped rules and methods (i.e., application and test scripts), data scoped actions including pre-conditions (i.e., state), side effects (i.e., application scripts), and expected events, and data scoped events (i.e., pre-conditions (i.e., state)), routing (i.e., navigation), side effects (e.g., application scripts), and a finite state machine (i.e., FSM). In some embodiments, states, actions, and events represent an integrated FSM that is defined based on an aggregated application state (i.e., SUT 104). Functionality may also be varied and is not limited to the descriptions provided.

Here, TF model module 300 generates models of applications or systems under test (e.g., SUT 104). In some embodiments, TF model module 300 may be implemented as TF model module 112 (FIG. 1). Model patterns module 302 generates a model using patterns derives from the application framework of SUT 104 (FIG. 1). Model patterns may also include super-classes, interfaces, linking entities, and other attributes that may be configured as part of a model. Using patterns to construct a model of SUT 104, TF model module 300 uses test scripts generated from script engine 206 to test the application or system under test (i.e., SUT 104). Further, metadata may be augmented manually using XML editor 114 (FIG. 1). This metadata may then be stored in model repository 304 and used to generate data schemas that are stored in model schema repository 306. In some embodiments, model schemas generated determine what types of indexes, tables, views, and other information should be included with a model of a given application being tested (i.e., SUT 104). In other embodiments, model schemas may be varied. Further, TF model module 300 and the above-described components may be varied and are not included to the components shown or the functions described.

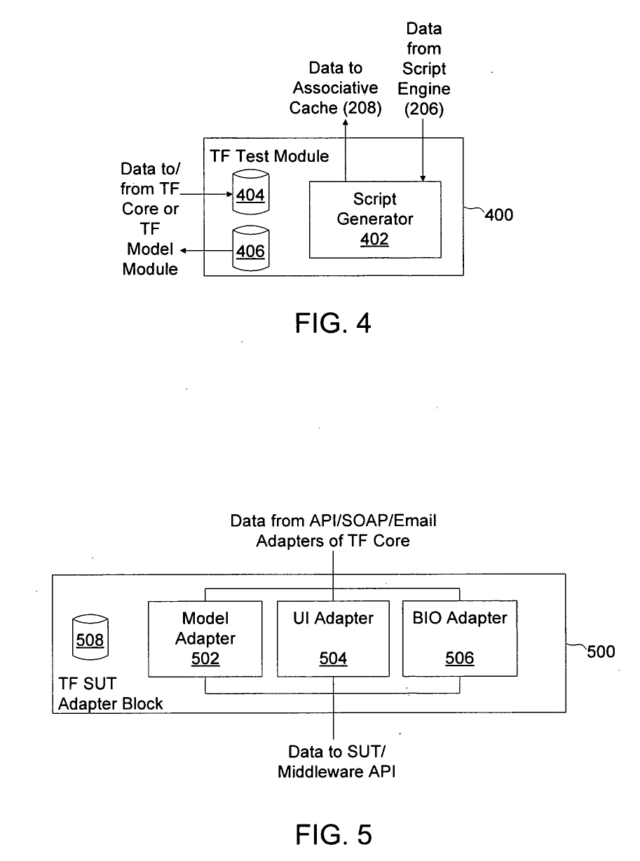

FIG. 4 illustrates an exemplary test framework (TF) test module configured for multi-tiered model-based application testing, in accordance with an embodiment. In some embodiments, TF test module 400 includes script generator module 402, configuration repository 404, and configuration schema 406. In other embodiments, TF test module 400 may include more, fewer, or different modules, interfaces, and components apart from those shown. Functionality may also be varied and is not limited to the descriptions provided.

Here, TF test module 400 is configured to generate test scripts, which are programs or applications that are used to test models of applications generated by TF model module 112 (FIG. 1). In some embodiments, TF test module 400 may be implemented as TF test module 110 (FIG. 1). Script generator 402 produces or generates test scripts in Java using, as an example, a J2EE web services or application development environment, as provided by TF J2EE service 108. Script generator 402 receives data from script engine 206 in and outputs data to associative cache 208, both of which are resident modules in TF core 200 (FIG. 2). In other embodiments, script engine 206 and associative cache 208 may be implemented as part of apart from TF core 200.

In some embodiments, configuration repository 404 may be implemented as a database configured to store configuration data received from TF core 200. Also, configuration schema repository 406 uses configuration data to generate data schemas that are stored in configuration schema repository 406 and output to TF model module 112 (FIG. 1) for use in testing models of SUT 104. In other embodiments, TF test module 400 and the above-described components and functions may be implemented differently.

FIG. 5 illustrates an exemplary test framework (TF) system under test (SUT) adapter block configured for multi-tiered model-based application testing, in accordance with an embodiment. In some embodiments, TF SUT adapter block 500 includes model adapter 502, user interface (“UI”) adapter 504, object (BIO) adapter 506, and presentation patterns repository 508. In other embodiments, TF SUT adapter block 500 may include more, fewer, or different modules, interfaces, and components apart from those shown. Functionality may also be varied and is not limited to the descriptions provided.

Here, TF SUT adapter block 500 is configured to exchange data and metadata from SUT 104 (FIG. 1) using one or more adapters that are configured for different architectural layers in a multi-tiered enterprise application. In some embodiments, TF SUT adapter block 500 may be implemented as TF SUT adapter block 116 (FIG. 1). One or more adapters may be used to gather data from various layers (e.g., client, application, business, service definition/discovery, and others) of an application. Here, model adapter 502 gathers data and metadata used to construct and generate a model for testing SUT 104. UI adapter 504 gathers data and metadata from the client or presentation layer, which may include data extracted from HTTP requests and the like. UI adapter 504 gathers data and metadata that may be used to generate test scripts for testing a model of SUT 104 (FIG. 1). BIO adapter 506 is configured to gather object data and metadata. BIO adapter 506 gathers data associated with objects such as BIOs (i.e., object classes and types such as those developed by E.piphany, Inc. of San Mateo, Calif.). In other embodiments, model adapter 502, UI adapter 504, and BIO adapter 506 may be implemented differently. Presentation pattern repository 508 is configured to store data and metadata gathered from adapters 502-506, which provide data and metadata from the presentation layer of an application. Presentation pattern data and metadata stored in presentation pattern repository 508 may be used to augment metadata that is automatically gathered from SUT 104. Further, by allowing manual augmentation of metadata for generating test scripts, tests may be customized for an application while increasing the efficiency and speed of testing. In other embodiments, TF SUT adapter block 500, the described components and functions may be implemented differently and are not limited to the descriptions provided above.

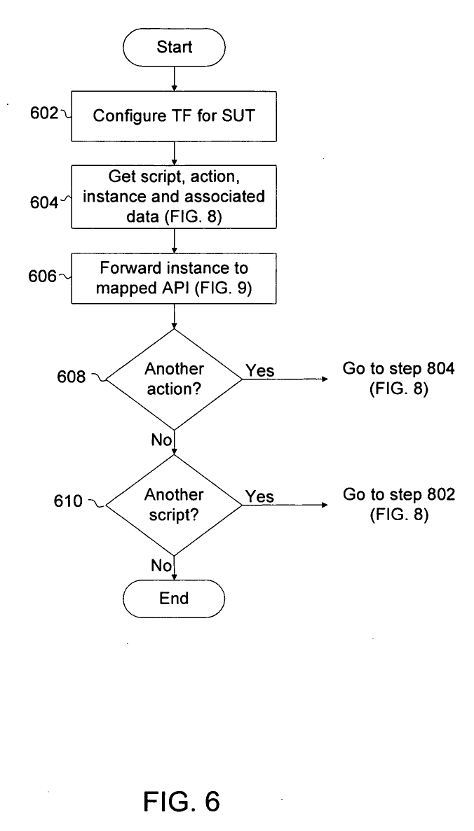

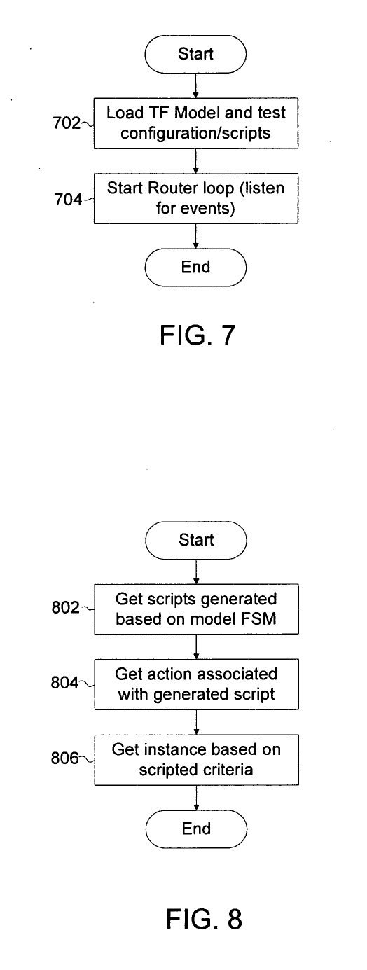

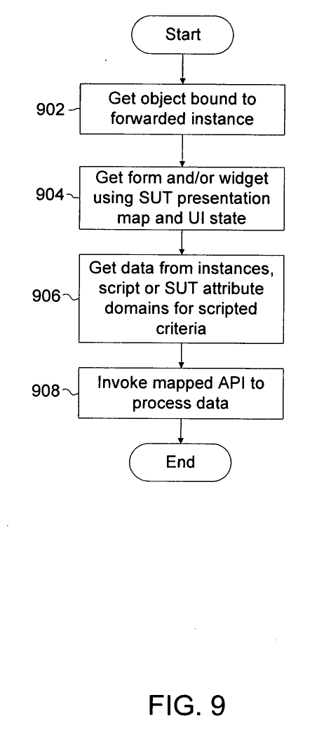

FIG. 6 illustrates an exemplary process for multi-tiered model-based application testing, in accordance with an embodiment. Here, an example of an overall process for multi-tiered model-based application testing is shown. In some embodiments, TF is configured for a given SUT (602). Configuration may be implemented as further described below in connection with FIG. 7. Referring back to FIG. 6, script engine 206 (FIG. 2) gets scripts, actions to be performed using the scripts, instances (i.e., a data image of a business object instantiated in the TF internal (i.e., associative) cache), and associated data and/or metadata. As described herein, “get” and “resolved” may be used interchangeably, where “resolved” may be used to refer to an algorithm of generating instances based on the current TF internal cache state. This may be implemented as further described below in connection with FIG. 8. Referring back to FIG. 6, the resolved instance actions are forwarded from, for example, SUT 104 (FIG. 1) to a mapped API and middleware such as TF SUT hook 118 for processing (606). Processing is described in greater detail below in connection with FIG. 9.

Referring back to FIG. 6, processing an event may include receiving the instance and retrieving associated objects (e.g., BIOs), forms, or other data or metadata that are required to create or instantiate the instance. As an example, a test script for testing a user interface for a sales application may be generated along with the user-initiated action “submit sales contact information” with an instance of a business object that stores this information. The script, action, and instance are forwarded via various adapters (e.g., as described in connection with FIG. 5) to TF 102 as an API calls. The adapters are also configured to receive object (e.g., BIO) information, forms, values associated with the object, and other data that may be used to invoke the object and test it using the gathered scripts. After processing an API call, a notification (i.e. a TF event) is sent to TF 102 (FIG. 1) using TF SUT hook 118 signaling completion of action processing (608). The processed event is routed to the instance (610). The event is routed to an instance or forwarded to the TF J2EE service (108) for use by TF 102 to test a model of an application or system under test (e.g., SUT 104) (610). After the event has been routed, a determination is made as to whether to get another action (612). If another action is selected, then step 804 of FIG. 8 is invoked. If another action is not requested (i.e., user or TF does not issue another “get” request), then a determination is made as to whether another script is available (614). If another script is available, then step 802 of FIG. 8 is invoked. If another script is not subject to another “get” command, then the process ends. In some embodiments, the above-described process may be manually or automatically performed. Manual performance may include a user entering commands (e.g., HTTP requests, “get” requests, and others) via a user interface or by entering metadata using an XML editor in order to generate tests and apply them to actions and objects of SUT 104. The above-described process may be performed automatically with or without manually augmented data or metadata to run TF 102 against SUT 104. In other embodiments, the above-described process may be varied and is not limited to the processes or descriptions provided.

FIG. 7 illustrates an exemplary process for configuring a test framework (TF), in accordance with an embodiment. Here, TF model module 112 (FIG. 1) is loaded using a model to be tested and test configuration data, metadata, and test scripts (702). Once loaded, associative cache 208 (FIG. 2) is created, which stores loaded XML elements. Further, router 204 (FIG. 2) begins listening for events (i.e., instances processed as events for testing as described above in connection with FIG. 6) (704). The above-described process may be varied and is not limited to the descriptions provided.

FIG. 8 illustrates an exemplary process for getting script, action, instance and associated data, in accordance with an embodiment. In some embodiments, scripts are generated based on a FSM used by TF model module 112 and are gathered using “get” requests (802). After getting the test scripts, actions associated with the scripts are gathered using “get” requests (804). After getting actions associated with generated scripts, instances are gathered using “get” requests (806). In some embodiments, instances are gathered based on scripted criteria. As an example, configuration of TF model module 112 includes gathering scripts, actions, and instances (i.e., objects as defined by classes used by TF 102) for testing a SUT 104. However, the scripts, actions, and instances are tested against a model of SUT 104 instead of SUT 104, which avoids disrupting or interrupting performance of an application that has been implemented. The above-described process may be varied and is not limited to the descriptions provided.

FIG. 9 illustrates an exemplary process for forwarding an instance action, in accordance with an embodiment. Here, TF 102 (FIG. 1) may be configured to get an object bound to a forwarded instance (902). In some embodiments, an instance determines what objects, as part of a class, are to be retrieved based on data values included with the instance. Instances may be determined based on scripted criteria such as superlinks and the like. In other embodiments, objects bound to forwarded instances may be determined differently. Next, forms and widgets (i.e., a component, sub-process, or function associated with a UI such as a box, bar, window, or other element used to present data on the UI) are retrieved from SUT presentation layer mapped to TF 102 and UI state information (904). Data from instances, scripts, or SUT attributed domains used to specify scripted criteria are also retrieved (906). Using the object, form, widget, and data values gathered from the forwarded instance, a mapped API is invoked in order to process the gathered items and perform further processing and testing. In other embodiments, the above-described process may be varied and is not limited to the descriptions provided.

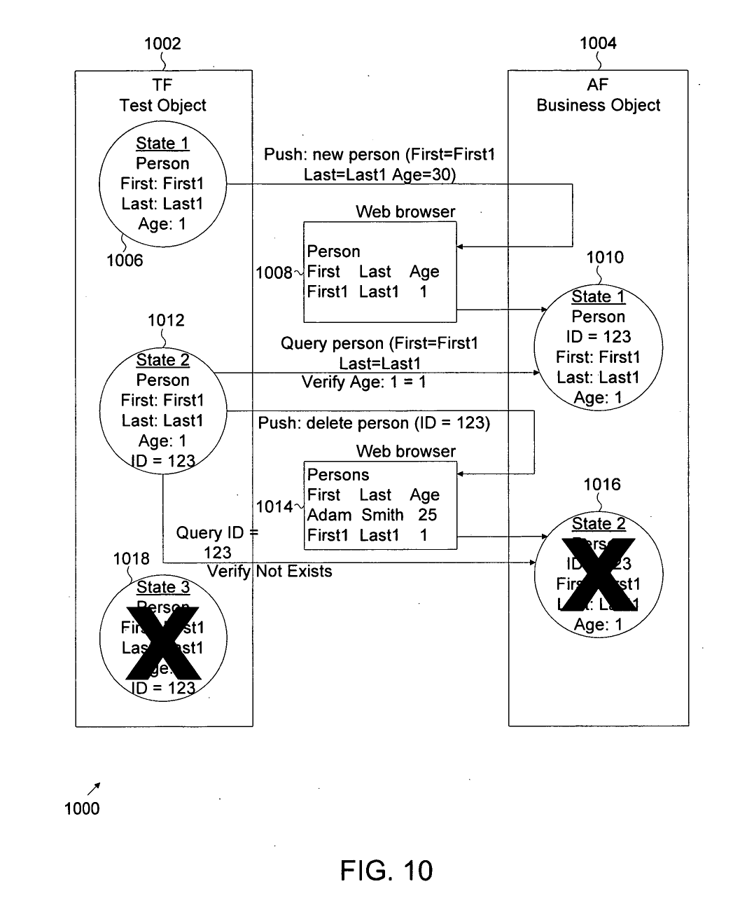

FIG. 10 illustrates an exemplary run-time test cycle for a test script generated using a system for multi-tiered model-based application testing, in accordance with an embodiment. Here, test process 1000 includes test object 1002, AF business object 9“BIO”) 1004, states 1006, 1010-1012, 1016-1018, and windows 1008 and 1014. In some embodiments, test object 1002 may be tested against AF business object (“BIO”) 1004 using states 1006, 1010-1012, 1016-1018 and windows 1008 and 1014. At run-time, state 1006 is created for test object 1002. States 1006, 1010-1012, and 1016-1018 may indicate one or more data values for an object (e.g., test object 1002, AF BIO 1004) at a given point in time or process. Here, state 1006 indicates test object 1002 has values “Person,” “First: First 1,” “Last: Last1,” and “Age: 1.” These may be values or fields that are used to indicate values for test object 1002 or AF BIO 1004. Test object 1002, at state 1006, is then pushed to a web browser where one or more values may be entered in window 1008. As an example, “First,” “Last,” and “1” appear under labels “Person,” “First,” “Last,” and “Age,” which are data values represented in state 1006. Once entered, data values provided in window 1008 update state 1010. Also, state 1012 is compared to state 1010 so that test object 1002 is properly modeled and includes data values also found in state 1012. A test or query is run against state 1010, yielding additional information such as “ID-123.” Next, information, data values, actions, and other state information may be pushed from state 1012 to window 1014 for presentation on a UI to a user. As an example, an action that deletes an object or instance associated with “ID-123” may be deleted and TF verifies that other duplicate objects or state information does not exist to ensure that the change is made by the model consistent with the application being tested (e.g., SUT 104 (FIG. 1)). In other embodiments, the above-described process for testing between a TF and AF may be performed differently and is not limited to the descriptions provided.

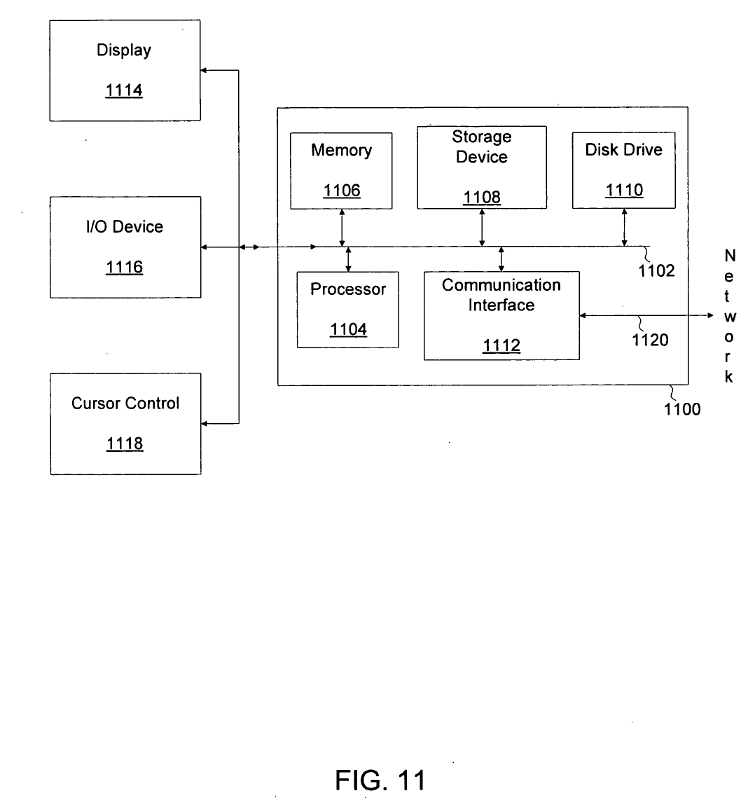

FIG. 11 is a block diagram illustrating an exemplary computer system suitable for multi-tiered model-based application testing, in accordance with an embodiment. In some embodiments, computer system 1100 may be used to implement computer programs, applications, methods, or other software to perform the above-described techniques for fabricating storage systems such as those described above. Computer system 1100 includes a bus 1102 or other communication mechanism for communicating information, which interconnects subsystems and devices, such as processor 1104, system memory 1106 (e.g., RAM), storage device 1108 (e.g., ROM), disk drive 1110 (e.g., magnetic or optical), communication interface 1112 (e.g., modem or Ethernet card), display 1114 (e.g., CRT or LCD), input device 1116 (e.g., keyboard), and cursor control 1118 (e.g., mouse or trackball).

According to some embodiments of the invention, computer system 1100 performs specific operations by processor 1104 executing one or more sequences of one or more instructions stored in system memory 1106. Such instructions may be read into system memory 1106 from another computer readable medium, such as static storage device 1108 or disk drive 1110. In some embodiments, hard-wired circuitry may be used in place of or in combination with software instructions to implement the invention.

The term “computer readable medium” refers to any medium that participates in providing instructions to processor 1104 for execution. Such a medium may take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some embodiments of the invention, execution of the sequences of instructions to practice the invention is performed by a single computer system 1100. According to some embodiments of the invention, two or more computer systems 1100 coupled by communication link 1120 (e.g., LAN, PSTN, or wireless network) may perform the sequence of instructions to practice the invention in coordination with one another. Computer system 1100 may transmit and receive messages, data, and instructions, including program, i.e., application code, through communication link 1120 and communication interface 1112. Received program code may be executed by processor 1004 as it is received, and/or stored in disk drive 1110, or other non-volatile storage for later execution.

Although the foregoing embodiments have been described in some detail for purposes of clarity of understanding, implementations of the above-described system and techniques is not limited to the details provided. There are many alternative implementations and the disclosed embodiments are illustrative and not restrictive.

What is claimed is:

1. A method for testing an application, comprising:
receiving metadata from the application, the metadata being associated with one or more layers of the application;
using the metadata to develop a script configured to test a feature of an application model; and
converting the metadata to develop another script configured to test another feature of the application model, wherein the another script is generated by the test framework.

2. The method recited in claim 1, wherein the one or more layers of the application includes a business layer.

3. The method recited in claim 1, wherein the one or more layers of the application includes a presentation layer.

4. The method recited in claim 1, wherein the one or more layers of the application includes an application layer.

5. The method recited in claim 1, wherein the one or more layers of the application includes an integration layer.

6. The method recited in claim 1, wherein the one or more layers of the applications includes an architectural layer of a system under test.

7. The method recited in claim 1, wherein the metadata is loaded into a loader, the loader being configured to convert the metadata.

8. The method recited in claim 1, wherein using the metadata further comprises manually entering metadata using an editor.

9. The method recited in claim 1, wherein the test framework is configured to manipulate metadata automatically or by using an editor.

10. The method recited in claim 1, wherein the metadata associated with a business layer includes an object.

11. The method recited in claim 1, wherein the metadata associated with a presentation layer includes metadata gathered in response to a request.

12. The method recited in claim 1, wherein the metadata associated with a presentation layer includes metadata gathered from a user interface.

13. The method recited in claim 1, wherein the application is an enterprise application.

14. The method recited in claim 1, wherein the feature is performance of the application.

15. The method recited in claim 1, wherein the metadata is exported from the application to the test framework using an adapter.

16. The method recited in claim 15, wherein the adapter is a model adapter.

17. The method recited in claim 15, wherein the adapter is an interface adapter.

18. The method recited in claim 15, wherein the adapter is an object adapter.

19. A system for testing an application, comprising:
a memory configured to store data associated with the application, the data including metadata;
a processor configured to receive metadata from the application, the metadata being associated with one or more layers of the application, using the metadata to develop a script configured to test a feature of an application model, and converting the metadata to develop another script configured to test another feature of the application model, wherein the another script is generated by the test framework.

20. A computer program product for testing an application, the computer program product being embodied in a computer readable medium and comprising computer instructions for:
receiving metadata from the application, the metadata being associated with one or more layers of the application;
using the metadata to develop a script configured to test a feature of an application model; and
converting the metadata to develop another script configured to test another feature of the application model, wherein the another script is generated by the test framework.
